(19) United States
(12) Patent Application Publication
(10) Pub. No.: US 2023/0238594 A1
(43) Pub. Date: Jul. 27, 2023

(54) LITHIUM BATTERY SYSTEM AND CHARGE-DISCHARGE METHOD OF THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHUN-HSIEN CHO, New Taipei (TW); KUO-CHIH YU, New Taipei (TW); LI-TING CAI, Houston, TX (US)

(21) Appl. No.: 18/085,900

(22) Filed: Dec. 21, 2022

(30) Foreign Application Priority Data
Jan. 21, 2022 (CN) 202210074480.0

(51) Int. Cl. H01M 10/44; H01M 10/635; H01M 10/48; H01M 10/613; H01M 10/052; H02J 7/00

(52) U.S. Cl. CPC H01M 10/443; H01M 10/635; H01M 10/486; H01M 10/613; H01M 10/052; H02J 7/007194; H01M 2010/4271

(57) ABSTRACT

A lithium battery system is provided. The lithium battery system comprises a battery pack, a battery management module, and a cooling control module. The battery pack comprises a first battery module and a second battery module having different battery characteristics. The battery management module is electrically connected to the battery pack, and configured to control an operating condition of the battery pack according to the battery characteristics of the first battery module and the second battery module. The cooling control module is electrically connected to the battery management module and the battery pack, and configured to cool the battery pack according to an instruction of the battery management module. The application combines a variety of lithium batteries with different performances to obtain a lithium battery system with excellent comprehensive performance.

### CROSS-REFERENCE TO RELATED APPLICATIONS

This application claims all benefits accruing under 35 U.S.C. § 119 from China Patent Application No. 202210074480.0, filed on Jan. 21, 2022, in the China Intellectual Property Office, the contents of which are hereby incorporated by reference.

### FIELD

The present disclosure relates to lithium battery technology field, especially relates to a lithium battery system and a charge-discharge method of the lithium battery system.

### BACKGROUND

Currently, common lithium batteries comprise lithium cobalt oxide batteries, lithium manganate batteries, lithium titanate batteries, lithium iron phosphate batteries and ternary lithium batteries, etc. The common lithium batteries are named based on active materials of their positive electrodes, and the lithium batteries have different performance characteristics. A single type of lithium battery cannot be simultaneously meet the excellent in cycle life, safety, low temperature performance, high temperature performance, energy density, stability, cost, and charging speed, etc. For example, the lithium cobalt oxide battery has high cost, the lithium manganate battery has poor high temperature performance, the ternary lithium battery has high cost and complex process, the lithium titanate battery has low energy density and high cost, and so on. Therefore, applications of the single type of lithium battery is very limited. Even a ternary lithium battery with a high operating temperature range is characterized by huge performance differences at different temperatures, and therefore, resulting in voltage rebound and affecting cycle life.

Therefore, there is need to explore a solution for a lithium battery with excellent comprehensive property, which is suitable for complex and wide use environments.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views. Implementations of the present technology will be described, by way of example only, with reference to the attached figures, wherein:

FIG. 1 is a function module diagram of a lithium battery system of one embodiment of the present application.

FIG. 2 is a flowchart of steps of a charge-discharge method of a lithium battery system of one embodiment of the present application.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “comprise,” when utilized, means “include, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly include at least one of the feature.

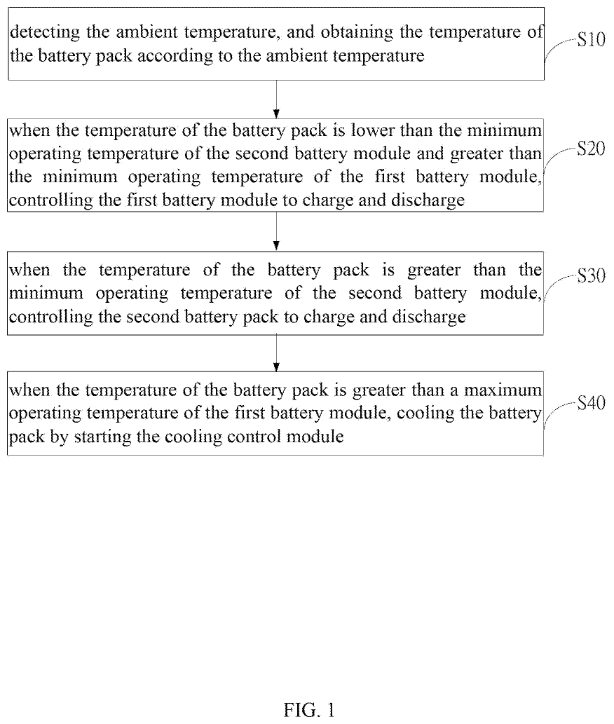

Referring to FIG. 1, one embodiment is described in relation to a lithium battery system 100. The lithium battery system 100 comprises a battery pack 10, a battery management module 20, and a cooling control module 30. The battery pack 10 comprises a first battery module 11 and a second battery module 12. The first battery module 11 and the second battery module 12 have different battery characteristics. The battery management module 20 is electrically connected to the battery pack 10, and the battery management module 20 can control an operating condition of the battery pack 10 according to the battery characteristics of the first battery module 11 and the second battery module 12. The cooling control module 30 is electrically connected to the battery management module 20. The cooling control module 30 is used to cool the battery pack 10 according to an instruction of the battery management module 20.

The battery pack 10 can comprise a lithium battery. For example, the lithium battery can be lithium cobaltate oxide (LCO), lithium manganese oxide (LMO), lithium titanium oxide (LTO), ferrous lithium phosphate (LiFePO4, LFP), ternary lithium battery (NMC/NCA) or other common lithium batteries. Properties of lithium batteries with different polar materials are different. For example, LCO has excellent reversibility, high energy density, but poor safety and high cost; LMO has excellent safety, low cost, but poor performance recovery at high temperature; and the ternary lithium battery has high energy density, excellent cycle performance, excellent thermal stability, but high cost and complex manufacturing process. In one embodiment, the battery pack 10 selects two kinds of lithium batteries with different properties, to combine each property of the two kinds of lithium batteries, thereby improving a comprehensive property of the lithium battery system 100.

An electrolyte of the lithium battery system 100 is not limited. The lithium battery system 100 can comprise liquid, gel, semi-solid, quasi-solid or all-solid types. A number of battery modules of the battery pack 10 are not limited. In one embodiment, the number of the battery module is more than two.

The battery management module 20 is electrically connected to the battery pack 10. The first battery module 11 and the second battery module 12 can be separately controlled by the battery management module 20 according to a temperature of the battery pack 10, to improve an overall performance of the battery pack 10.

The cooling control module 30 can comprise an air-cooled cooling device or a liquid-cooled cooling device. A cooling medium of the cooling control module 30 can be water, oil or other heat transfer medium. A specific structure, a cooling method and the cooling medium of the cooling control module 30 are not limited, as long as the battery pack 10 can be cooled. The cooling control module 30 is electrically connected to the battery management module 20 and cools the battery pack 10 under a control of the battery management module 20.

In one embodiment, the battery pack 10 further comprises a sensor 40, the sensor 40 is electrically connected to the battery management module 20, and the sensor 40 is used to detect environmental parameters of the battery pack 10. The battery management module 20 controls charge and discharge the battery pack 10, or start and stop of the cooling control module 30 according to the environmental parameters. The sensor 40 can comprise a temperature sensor 40 or a pressure sensor 40, to detect a temperature or an air pressure of the battery pack 10 or an environment around the battery pack 10. An ambient temperature of the battery pack 10 can be used to indirectly obtain the temperature of the battery pack 10, but the battery pack 10 is usually sealed, there may be a safety hazard when the pressure is abnormal.

In one embodiment, the environmental parameters can comprise ambient temperature and/or ambient air pressure. A type of the environmental parameters depends on a type of the sensor 40.

In one embodiment, the battery characteristics can comprise one or more of energy density, operating temperature range, service life, and discharge capacity.

In one embodiment, the first battery module 11 or the second battery module 12 can comprise one of the lithium cobalt oxide battery, the lithium manganate battery, the lithium titanate battery, the lithium iron phosphate battery, and the ternary lithium battery.

In one embodiment, the battery pack 10 can further comprise a temperature conduction device. The temperature conduction device connects the first battery module 11 and the second battery module 12, and transfers a heat of the first battery module 11 and a heat of the second battery module 12 to each other, to balance the temperature of the first battery module 11 and the temperature of the second battery module 12. Therefore, the temperature of the first battery module 11 and the temperature of the second battery module 12 have a tendency to change toward an average temperature of the first battery module 11 and the second battery module 12.

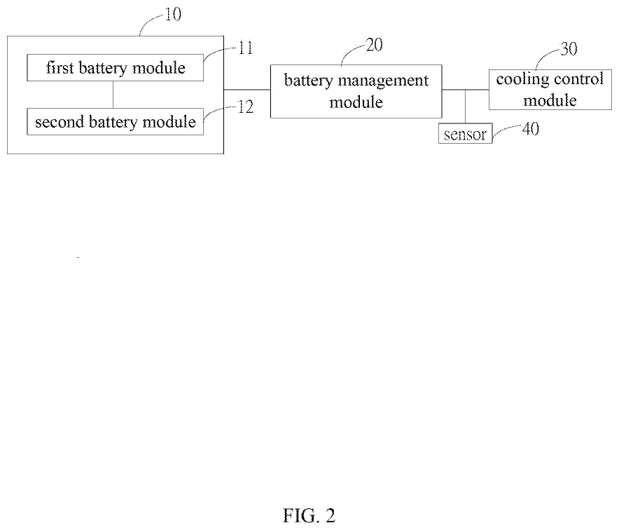

Referring to FIG. 2, one embodiment is described in relation to a charge-discharge method, and the charge-discharge method is used to the lithium battery system 100. The lithium battery system 100 comprises the battery pack 10, the battery management module 20, and the cooling control module 30. The battery pack 10 comprises the first battery module 11 and the second battery module 12. A minimum operating temperature of the first battery module 11 is lower than a minimum operating temperature of the second battery module 12; generally, battery types with a wide operating temperature range have relatively low energy density. In one embodiment, the first battery module 11 can be LTO or LFP, the second battery module 12 can be LCO, LMO or ternary lithium battery.

The charge-discharge method comprises steps as follows.

Step (S10): detecting the ambient temperature, and obtaining the temperature of the battery pack 10 according to the ambient temperature.

In step (S10), a current temperature of the battery pack 10 of the lithium battery system 100 can be directly or indirectly obtained by setting the sensor 40.

Step (S20): when the temperature of the battery pack 10 is lower than the minimum operating temperature of the second battery module 12 and greater than the minimum operating temperature of the first battery module 11, controlling the first battery module 11 to charge and discharge.

The first battery module 11 with a lower operating temperature is first started to charge and discharge, and the battery pack 10 can be partially charged and discharged. In this process, the first battery module 11 generates heat, and the heat can increase the temperature of the entire battery pack 10 through heat conduction; therefore, the temperature of the second battery module 12 can be increased to an operable temperature, and subsequently, the second battery module 12 with high energy density can be used for charging and discharging.

Step (S30): when the temperature of the battery pack 10 is greater than the minimum operating temperature of the second battery module 12, controlling the second battery pack 10 to charge and discharge.

Through step (S20) and step (S30), an operating temperature range of the entire battery pack 10 can be expanded; and a utilization rate of the second battery module 12 with high energy density can also be improved, thereby improving a comprehensive charge and discharge performance of the battery pack 10 in a wider dimension.

Step (S40): when the temperature of the battery pack 10 is greater than a maximum operating temperature of the first battery module 11, cooling the battery pack 10 by starting the cooling control module 30.

In step (S40), after charging and discharging for a period of time, the temperature may gradually exceed the maximum operating temperature of the battery pack 10. At this point, the temperature of the battery pack 10 can be detected and the battery module that has been exposed to unfavorable high temperatures can be turned off. At the same time, the cooling control module 30 is started to cool down the battery pack 10, and then the corresponding battery module is started until the temperature drops to a suitable operating temperature range.

In this way, the second battery module 12 with a high minimum operating temperature range but high energy density can work within its suitable operating temperature range as much as possible. At the same time, it is also avoided to allow the first battery module 11 with low minimum operating temperature, high cycle life, high discharge rate but low energy density to work at low temperature for a long time. Therefore, the battery pack 10 is kept in a suitable operating temperature range for more time, and the overall performance is improved.

In one embodiment, after the step (S40) of when the temperature of the battery pack 10 is greater than the maximum operating temperature of the first battery module 11, cooling the battery pack 10 by starting the cooling control module 30, further comprising a step of: when the temperature of the battery pack 10 exceeds the maximum operating temperature of the second battery module 12 or the first battery module 11, stopping charging and discharging the second battery module 12 or the first battery module 11, and controlling the first battery module 11 or the second battery module 12 to drive the cooling control module 30.

What needs to be explained is that when the temperature of the battery pack 10 exceeds the lower maximum operating temperature of the first battery module and the second battery module, the charging and discharging of the battery module with the lower maximum operating temperature is stopped, and the cooling control module 30 is driven by discharging another battery module with a higher maximum operating temperature to reduce the temperature.

When the temperature of the battery pack 10 is lower than the maximum operating temperature of the second battery module 12 or the first battery module 11, stopping the first battery module 11 or the second battery module 12, and controlling the second battery module 12 or the first battery module 11 to drive the cooling control module 30.

What needs to be explained is that when the temperature drops below the operating temperature of the battery module with the lower maximum operating temperature, starting charging and discharging of the battery module with the lower maximum operating temperature, and stopping charging and discharging of another battery module with the higher maximum operating temperature. Thereby improving a service performance and the cycle life of the battery module with a large operating range.

In one embodiment, the step of when the temperature of the battery pack 10 exceeds the maximum operating temperature of the second battery module 12 or the first battery module 11, stopping charging and discharging the second battery module 12 or the first battery module 11, and controlling the first battery module 11 or the second battery module 12 to drive the cooling control module 30, further comprising a step of: when the temperature of the battery pack 10 is lower than the maximum operating temperature of the second battery module 12 or the first battery module 11, controlling the second battery module 12 and/or the first battery module 11 to drive the cooling control module 30.

What needs to be explained is that when the temperature of the battery pack 10 is lower than the temperature of the battery module with a lower maximum operating temperature, only the battery module with the lower maximum operating temperature can be activated, or both battery modules can be activated at the same time.

In one embodiment, in step (S40), when the temperature of the battery pack 10 is greater than the maximum operating temperature of the first battery module 11, starting the cooling control module 30 to cool the battery pack 10 comprises a step of driving the cooling control module 30 by an external power supply.

The lithium battery system 100 can be connected to the external power source, when the first battery module 11 and the second battery module 12 are both at a high temperature unsuitable for operation; the cooling control module 30 is activated by the external power source to reduce the temperature.

The lithium battery system 100 can include more than two battery modules, and the above charge-discharge method is also applicable to a control logic of any two battery modules among the more than two battery modules. The lithium battery system 100 is not limited to two battery modules.

The lithium battery system 100 of the present application can be used in scenes with a large temperature fluctuation range, such as a vehicle power system, a mobile terminal power supply system, and an industrial equipment energy system.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A lithium battery system comprising:
a battery pack comprising a first battery module and a second battery module, wherein the first battery module and the second battery module have different battery characteristics;
a battery management module electrically connected to the battery pack, and configured to control an operating condition of the battery pack according to a first battery characteristic of the first battery module and a second battery characteristic of the second battery module; and
a cooling control module electrically connected to the battery management module and the battery pack, and configured to cool the battery pack according to an instruction of the battery management module.

2. The lithium battery system of claim 1, further comprising a sensor electrically connected to the battery management module and the cooling control module, wherein the sensor is configured to detect environmental parameters of the battery pack.

3. The lithium battery system of claim 2, wherein the battery management module controls charging and discharging to the battery pack or starting and stopping of the cooling control module according to the environmental parameters.

4. The lithium battery system of claim 2, wherein the environmental parameters comprise at least one of an ambient temperature and an ambient air pressure.

5. The lithium battery system of claim 1, wherein the battery characteristics comprise at least one of energy density, operating temperature range, service life, and discharge capacity.

6. The lithium battery system of claim 1, wherein the first battery module comprises one of a lithium cobalt oxide battery, a lithium manganate battery, a lithium titanate battery, a lithium iron phosphate battery, and a ternary lithium battery.

7. The lithium battery system of claim 1, wherein the second battery module comprises at least one of a lithium cobalt oxide battery, a lithium manganate battery, a lithium titanate battery, a lithium iron phosphate battery, and a ternary lithium battery.

8. The lithium battery system of claim 1, wherein the battery pack further comprises a temperature conduction device connected to the first battery module and the second battery module, and the temperature conduction device is configured to balance a first temperature of the first battery module and a second temperature of the second battery module.

9. A charge-discharge method of a lithium battery system, wherein the battery system comprises a battery pack, a battery management module, and a cooling control module, the battery pack comprises a first battery module and a second battery module, and a first minimum operating temperature of the first battery module is lower than a second minimum operating temperature of the second battery module, the charge-discharge method comprises:
detecting an ambient temperature, and obtaining a temperature of the battery pack according to the ambient temperature; wherein
if the temperature of the battery pack is lower than the second minimum operating temperature of the second battery module and greater than the first minimum operating temperature of the first battery module, controlling the first battery module to charge and discharge; or
if the temperature of the battery pack is greater than the second minimum operating temperature of the second battery module, controlling the second battery pack to charge and discharge; or
if the temperature of the battery pack is greater than a first maximum operating temperature of the first battery module, cooling the battery pack by starting the cooling control module.

10. The charge-discharge method of claim 9, wherein if the temperature of the battery pack is greater than the maximum operating temperature of the first battery module, after cooling the battery pack by starting the cooling control module, the charge-discharge method further comprises:
if the temperature of the battery pack exceeds a second maximum operating temperature of the second battery module or the first maximum operating temperature of the first battery module, stopping charging and discharging to the second battery module or the first battery module, and controlling the first battery module or the second battery module to drive the cooling control module; or
if the temperature of the battery pack is lower than the second maximum operating temperature of the second battery module or the first maximum operating temperature of the first battery module, stopping the first battery module or the second battery module, and controlling the second battery module or the first battery module to drive the cooling control module.

11. The charge-discharge method of claim 9, wherein if the temperature of the battery pack is greater than the maximum operating temperature of the first battery module, after cooling the battery pack by starting the cooling control module, the charge-discharge method further comprises:
if the temperature of the battery pack is lower than the second maximum operating temperature of the second battery module or the first maximum operating temperature of the first battery module, controlling the second battery module and the first battery module to drive the cooling control module.

12. The charge-discharge method of claim 9, wherein if the temperature of the battery pack is greater than the maximum operating temperature of the first battery module, after cooling the battery pack by starting the cooling control module, the charge-discharge method further comprises:
if the temperature of the battery pack is lower than the second maximum operating temperature of the second battery module or the first maximum operating temperature of the first battery module, controlling the second battery module or the first battery module to drive the cooling control module.

13. The charge-discharge method of claim 9, wherein if the temperature of the battery pack is greater than the first maximum operating temperature of the first battery module, cooling the cooling control module by starting the battery pack comprises driving the cooling control module by an external power supply.
